(19) United States
(12) Patent Application Publication
(10) Pub. No.: US 2006/0268049 A1
(43) Pub. Date: Nov. 30, 2006

(54) Ink-jet image forming apparatus having cap member

(76) Inventors: Youn-gun Jung, Gunpo-si (KR); Heon-soo Park, Seongnam-si (KR)

Correspondence Address: STANZIONE & KIM, LLP, 919 18TH STREET, N.W., SUITE 440, WASHINGTON, DC, 20006, US

(21) Appl. No.: 11/332,365

(22) Filed: Jan. 17, 2006

(30) Foreign Application Priority Data
May 25, 2005 (KR) 2005-44230

(51) Int. Cl. B41J 2/165

(52) U.S. Cl. 347/29

(57) ABSTRACT

An ink-jet image forming apparatus includes an ink-jet head including a printbar having a plurality of nozzle plates, and a cap member including a base facing the printbar, a boundary wall disposed against the base to seal the printbar, and a protector protruding from the base to prevent the printbar from contacting the base.

### CROSS-REFERENCE TO RELATED APPLICATIONS

This application claims the benefit under 35 U.S.C. § 119 of Korean Patent Application No. 2005-44230, filed on May 25, 2005, in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus, and more particularly, to an ink-jet image forming apparatus having a cap member to cap a printbar.

2. Description of the Related Art

In general, an ink-jet image forming apparatus forms a desired image by ejecting ink droplets onto a recording medium from an ink-jet head reciprocating perpendicular to the conveying direction of the recording medium (e.g., a shuttle-type ink-jet head). The ink-jet head includes a printbar provided with a plurality of nozzles for ejecting the ink droplets. The ink droplets which are not properly ejected remain around the nozzles, where they solidify and attract dust and fine particles. The solidified ink droplets alter the ejection direction of the ink droplets subsequently ejected from the nozzles, thereby reducing the printing quality. Also, the solidified ink droplets can clog the nozzles. In order to prevent the above described phenomenon, it is necessary to isolate the printbar from the atmosphere while a printing operation is not performed.

Recently, a high speed printing has been achieved by using a wide ink-jet head (referred to as an array ink-jet head) instead of the shuttle-type ink-jet head. The wide ink-jet head includes a printbar having a length in a main scanning direction corresponding to a width of a recording medium. In an ink-jet image forming apparatus having the wide ink-jet head, the wide ink-jet head is stationary, and only the recording medium is conveyed. Hence, a drive mechanism of the ink-jet image forming apparatus having the wide ink-jet head is simple, and the high speed printing is possible. In this type of ink-jet image forming apparatus, the length of the printbar is about 210 mm so as to correspond to the width of an A4 size recording medium without considering a printing margin in a width direction of the recording medium. Consequently, when the printing operation is not performed, it is required to effectively isolate the long printbar from the exterior.

### SUMMARY OF THE INVENTION

The present general inventive concept provides an ink-jet image forming apparatus capable of effectively isolating a printbar of an ink-jet head from the atmosphere while a printing operation is not performed.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an ink-jet image forming apparatus including an ink-jet head including a printbar having a plurality of nozzle plates, and a cap member including a base facing the printbar, a boundary wall disposed against the base to seal the printbar, and a protector protruding from the base to prevent the printbar from contacting the base.

The protector may include a support pole disposed at a region of the base that does not face one of the plurality of nozzle plates. The support pole may have a height equal to or lower than a height of the boundary wall.

The protector may include a support wall disposed at a region that does not face one of the nozzle plates and extended along an edge of one of the plurality of nozzle plates. The support pole may have a height equal to or lower than a height of the boundary wall. The support wall may be separated from the boundary wall.

The printbar may have a main scanning direction corresponding to a width of a recording medium.

The cap member may be made of an elastic material.

The foregoing and/or other aspects of the present general inventive concept are also achieved by providing an ink-jet image forming apparatus including an array ink-jet head including a printbar having a length in a main scanning direction corresponding to a width of a recording medium, the printbar having a plurality of nozzle plates, and a cap member including a base facing the printbar, an elastomeric boundary wall disposed against the base to seal the printbar, and a support wall having a height equal to or lower than a height of the boundary wall and disposed at a region of the base that does not face one of the plurality of nozzle plates.

The support wall may be disposed along an edge of one of the plurality of nozzle plates. The support wall may be separated from the boundary wall.

The foregoing and/or other aspects of the present general inventive concept are also achieved by providing an ink-jet image forming apparatus having a printhead with nozzle plates, including a cap member to seal the printhead while a printing operation is not performed, the cap member including a protector to prevent the cap member from contacting the nozzle plates by maintaining at least a predetermined distance between the cap member and the printhead.

The foregoing and/or other aspects of the present general inventive concept are also achieved by providing a nozzle protecting system usable with an ink-jet image printing apparatus to prevent dried ink and dust from clogging ink ejecting nozzles while a printing operation is not performed, the system including a cap member including a plurality of protrusions to prevent cap member from contacting the nozzles by maintaining a predetermined distance between the cap member and the nozzles, a platen moving unit to move a platen between a first position during the printing operation and a second position when the printing operation is not performed, and a cap-member moving unit to move the cap member to cover the ink ejecting nozzles after the platen has been moved in the second position.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an ink-jet image forming apparatus according to an embodiment of the present general inventive concept;

FIG. 2 is a view of an embodiment of a printbar usable with the ink-jet image forming apparatus of FIG. 1;

FIG. 3 is a view of another embodiment of a printbar usable with the ink-jet image forming apparatus of FIG. 1;

FIG. 4 is a schematic view of an embodiment of a platen moving unit usable with the ink-jet image forming apparatus of FIG. 1;

FIG. 5 is a view illustrating the platen moving unit of FIG. 4 in a state wherein a platen is moved away from a printbar;

FIG. 6 is a schematic view of an embodiment of a cap-member moving unit usable with the ink-jet image forming apparatus of FIG. 1;

FIG. 7 is a view illustrating the cap-member moving unit of FIG. 6 in a state wherein a cap member is located in an uncapping position;

FIG. 8 is a view illustrating the cap moving member of FIGS. 6 and 7 in a state wherein the cap member is located in a capping position;

FIG. 9 is a perspective view of a cap member to cap the printbar illustrated in FIG. 2 according to one embodiment of the present general inventive concept;

FIG. 10 is a cross-sectional view illustrating a printbar that is capped by a cap member;

FIG. 11 illustrates a drawback of a base or a cap plate not being flat;

FIG. 12 is a perspective view of an embodiment of a cap member including a protector according to the present general inventive concept;

FIG. 13 is a perspective view of another embodiment of a cap member including a protector according to the present general inventive concept;

FIG. 14 is a perspective view of another embodiment of a cap member including a protector according to the present general inventive concept; and

FIG. 15 is a top plan view illustrating an embodiment of a cap member to cap the printbar illustrated in FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

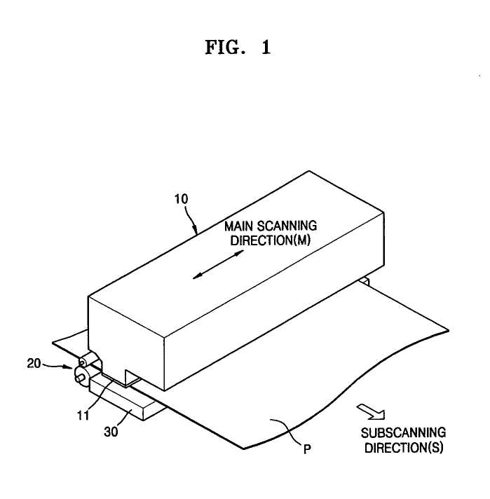

FIG. 1 is a perspective view illustrating an ink-jet image forming apparatus according to an embodiment of the present general inventive concept. Referring to FIG. 1, a recording medium P is conveyed in a subscanning direction S by a pair of rollers 20 rotating while engaged with each other. An ink-jet head 10 is located above the recording medium P. The ink-jet head 10 ejects ink droplets while in a fixed position to print an image on the recording medium P as the recording medium passes adjacent to the inkjet head 10.

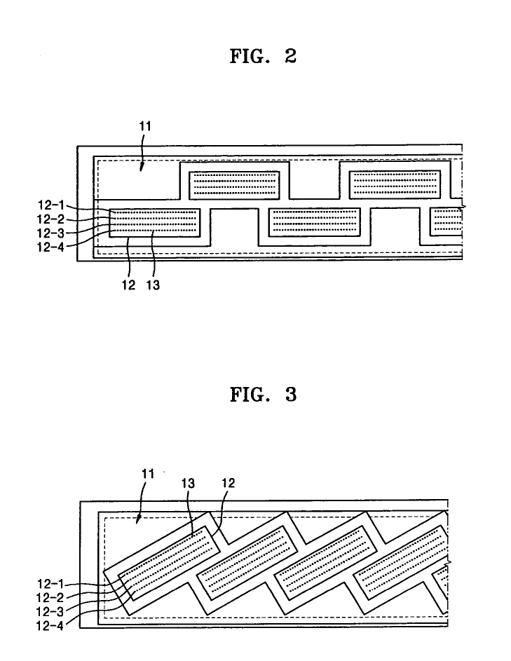

The ink-jet head 10 of the present embodiment is an array ink-jet head including a printbar 11 having a length in a main scanning direction M corresponding to a width of the recording medium P. FIGS. 2 and 3 are views of embodiments of the printbar 11. Referring to FIGS. 2 and 3, the printbar 11 includes a plurality of nozzle plates 12 arranged in the main scanning direction M. Each nozzle plate 12 includes a plurality of nozzles 13 that eject the ink droplets. The nozzle plate 12 may be provided with arrays of nozzles 12-1, 12-2, 12-3 and 12-4. The arrays of nozzles 12-1, 12-2, 12-3 and 12-4 may eject ink droplets of the same color or of different colors (for example, cyan, magenta, yellow, and black, respectively). The embodiments of the printbar 11 illustrated in FIGS. 2 and 3 are merely exemplary, and it should be understood that the embodiments are not intended to limit the scope of the present general inventive concept.

The ink-jet head 10 includes a chamber (not shown) communicating with each nozzle 13 and having a discharging unit that supplies pressure to discharge ink (e.g., a piezoelectric device, heater or the like), and a channel through which the ink is supplied into the chamber. The chamber, discharging unit and channel are well known to those skilled in the art, and thus are not described in detail herein.

A platen 30 is located to face the print bar 11 so that an interval (or distance) between the printbar 11 of the ink-jet head 10 and the recording medium P is maintained between 0.5 and 2 mm. The ink-jet head 10 is provided with means for discharging the printed recording medium P (not shown) at an outlet side thereof.

While a printing operation is not performed, if the printbar 11 is exposed to the atmosphere, ink droplets remaining around the nozzles 13 may solidify. In addition, dust or fine particles in the atmosphere may adhere to the printbar 11. The solidification of the ink droplets and/or adhesion of dust thereto alter the ejection direction of the ink droplets that are subsequently ejected, thereby reducing the printing quality. In time, due to a continuous accumulation of dried ink and dust, some of the nozzles 13 become clogged. When a nozzle of the nozzles 13 is clogged, since the array ink-jet head 10 prints the image while in the fixed position, a white or missing line appears on the printed image. In order to prevent the above described situation, the printbar 11 can be isolated (sealed) from the atmosphere by capping the printbar 11 when the printing operation is not performed.

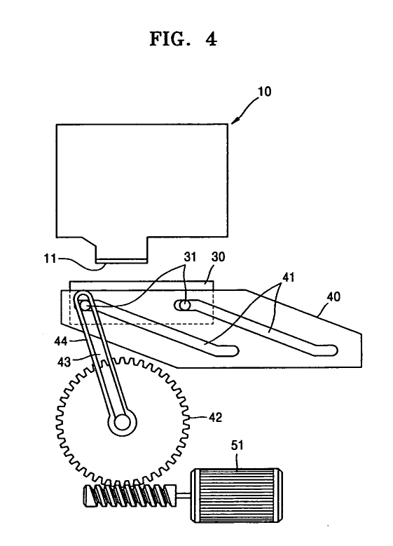

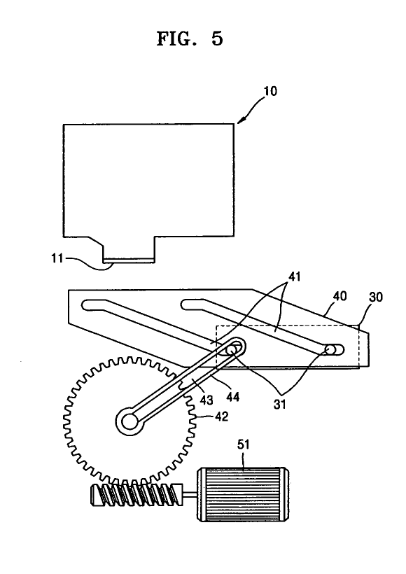

The platen 30 is moved away from beneath the printbar 11 before the printbar 11 is capped. One embodiment of a unit to move the platen 30 away from beneath the printbar 11 is illustrated in FIGS. 4 and 5. As can be seen from FIG. 4, the platen 30 is provided with at least one boss 31 disposed at a side wall of the platen 30. The boss 31 is inserted into a corresponding cam track 41 formed in a support member 40. A gear 42 has an arm 44 having a slot 43. The boss 31 is inserted into the slot 43 of the arm 44. The gear 42 is rotated by an electric motor 51. The platen 30 is moved along the cam track 41 according to the direction of rotation of the electric motor 51, to move the platen 30 away from beneath the printbar 11, as illustrated in FIG. 5, or to return the platen 30 to a position so that to maintain the interval (distance) between the recording medium P and the printbar 11, as illustrated in FIG. 4.

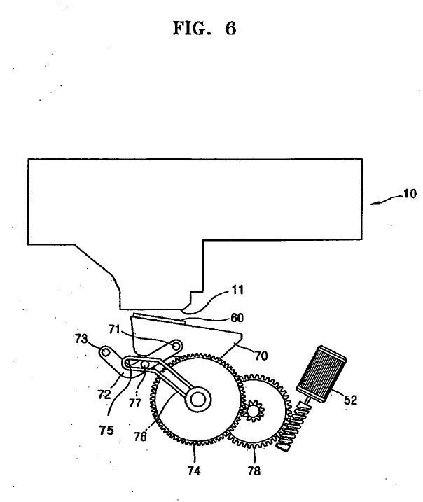

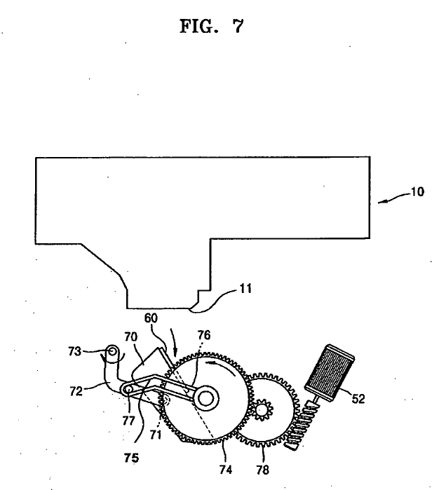

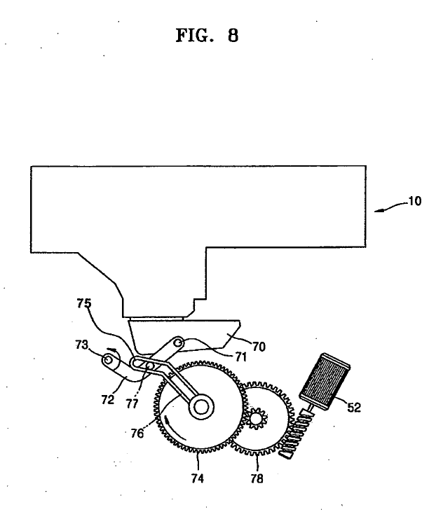

FIG. 6 is a schematic view of an embodiment of a cap-member moving unit to cap the printbar 11 with the cap member 60. As can be seen from FIG. 6, the cap member 60 that caps the printbar 11 is installed on a cap plate 70. The cap plate 70 is provided with a first boss 71 at a side wall of the cap plate 70. The first boss 71 is coupled to a pivot lever 72, which pivots around a hinge 73. A cam gear 74 has an arm 76 formed with a slot 75. A second boss 77 provided on the pivot lever 72 is inserted into the slot 75 of the arm 76. The cam gear 74 is rotated by an electric motor 52 through a gear 78. Hence, the pivot lever 72 is rotated around the hinge 73. With the above embodiment of the cap-member moving unit, the cap member 60 is moved between an uncapping position (FIG. 7) and a capping position (FIG. 8) by rotating the motor 52 in forward and reverse directions, respectively.

In order to perform the printing operation, the cap member 60 is moved to the uncapping position illustrated in FIG. 7, and the platen 30 is moved to the position illustrated in FIG. 4. When the printing operation is completed, the platen 30 is moved back to the position illustrated in FIG. 5, and the cap member 60 is moved to the position illustrated in FIG. 8.

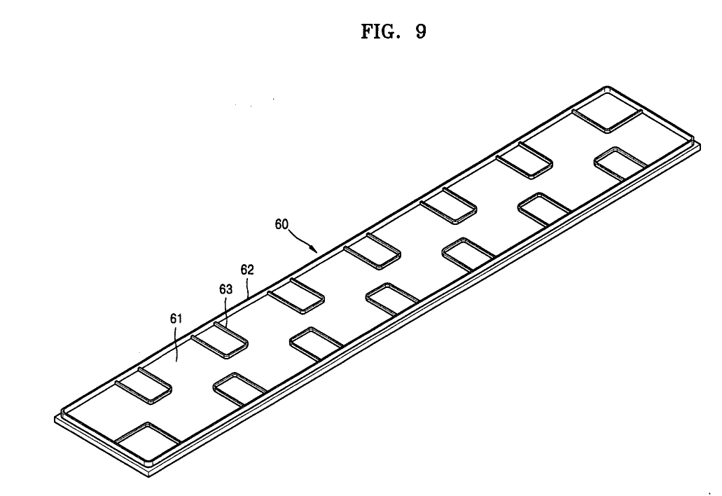

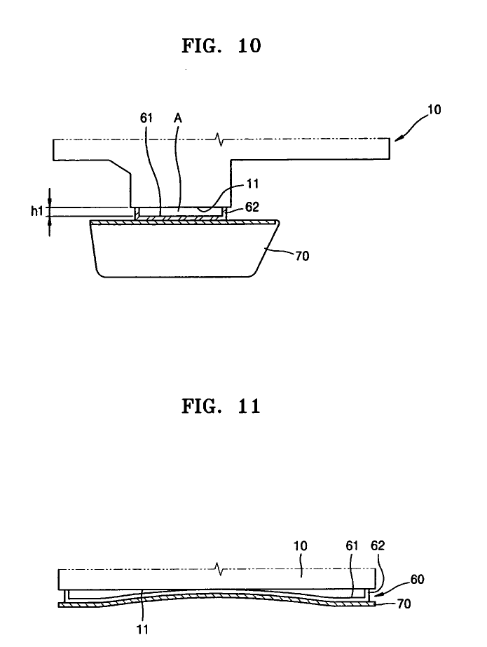

FIG. 9 illustrates the cap member 60 according to an embodiment of the present general inventive concept. For example, the cap member 60 illustrated in FIG. 9 can cap the printbar 11 illustrated in FIG. 2. Referring to FIG. 9, the cap member 60 includes a base 61 and a boundary wall 62. The base 61 faces the printbar 11. The boundary wall 62 contacts the printbar 11, and may be made of an elastomeric material, such as rubber. The base 61 and the boundary wall 62 may be integrally formed with the elastomeric material, such as rubber. When the cap member 60 is located in the capping position, the boundary wall 62 contacts and encloses (i.e., seals) the printbar 11. Hence, as illustrated in FIG. 10, a space A isolated from the atmosphere is formed by the printbar 11, the base 61 and the boundary wall 62. In this case, if any ink vaporizes from the printbar 11, when air in the space A becomes saturated, no more ink is vaporized. The smaller the volume of air in the space A, the faster the air becomes saturated. In other words, an amount of ink to be vaporized to saturate the air in the space A is reduced. If the volume of air in the space A is large, more ink remaining on the surface of the printbar 11 is vaporized to saturate the air, so that the viscosity of the ink is increased. The high viscosity ink may clog the nozzles 13 or alter the ejection direction of the ink droplets.

A height h1 of the boundary wall 62 is reduced as much as possible to minimize the volume of air in the space A. The length of the printbar 11 of the array ink-jet head 10 is generally larger than a length of the shuttle-type ink-jet head, that is typically 20 to 30 mm, or, in some cases, 50 to 70 mm. In particular, the length in the main scanning direction M of the printbar 11 of the array ink-jet head 10 for printing an A4 recording medium is about 210 mm. The base 61 must be very flat, but it is very difficult and expensive to maintain a high degree of flatness for the entire length of 210 mm or more. In particular, when the base 61 is made of an elastic material, the base 61 is supported by the cap plate 70 made of a steel plate or plastic. However, it is difficult to make the cap plate 70 flat. If the base 61 or the cap plate 70 is not flat, as illustrated in FIG. 11, the base 61 may contact the printbar 11 and damage the nozzles 13. Moreover, when the base 61 is made of a relatively solid material such as a steel plate or plastic, instead of the elastomeric material, the possibility of damaging the nozzles 13 due to repeated contact is further increased. Also, when the base 61 is spaced apart from the nozzles 13 to uncap the cap member 60 from the printbar 11, strong negative pressure may be applied to the nozzles 13, causing ink to leak through the nozzles 13. Though the above described type of problem may not occur at an initial stage of assembling the image forming apparatus, when the cap member 60 or the cap plate 70 is deformed over time, the base 61 may contact the printbar 11.

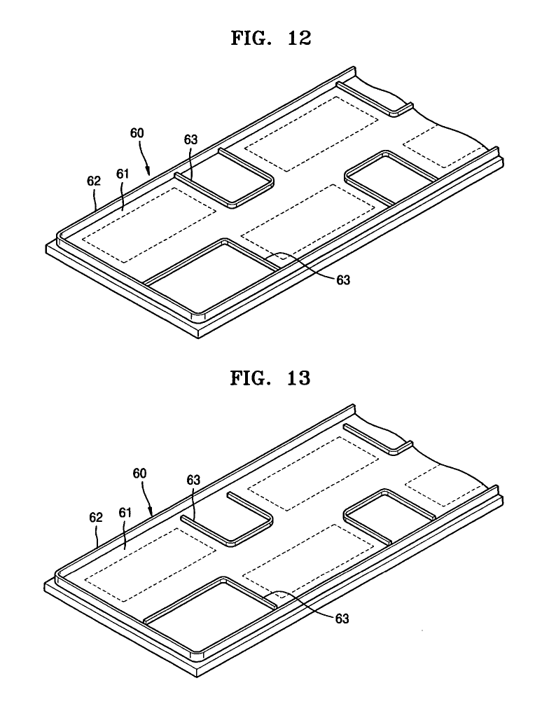

In order to overcome the above-described type of problem, the cap member 60 of the present embodiment has a protector to reduce the height h1 of the boundary wall 62. Referring to FIGS. 9 and 12, a support wall 63 is illustrated as an embodiment of the protector. According to the present embodiment of protector, though the base 61 or the cap plate 70 is not flat, the support wall 63 contacts the printbar 11 first and keeps the base 61 away from the nozzles 13. Regions of the base 61 indicated by a dotted line in FIG. 12 face the nozzle plates 12. The support wall 63 is provided in a position out of the regions facing the nozzle plates 12, and may be provided along an edge of one of the nozzle plates 12. Since the support wall 63 is provided in a position where it does not contact any of the nozzle plates 12, it is possible to prevent the base 61 from contacting the printbar 11 without damaging the nozzles 13. The support wall 63 has a height equal to or lower than the height h1 of the boundary wall 62 which resiliently contacts the printbar 11 to isolate the space A from the atmosphere. If the support wall 63 is higher than the boundary wall 62, a gap occurs between the boundary wall 62 and the printbar 11, so that an airtight space A is not maintained. Furthermore, the boundary wall 62 makes airtight contact with the printbar 11 by separating the support wall 63 from the boundary wall 62. Additionally, the support wall 63 may be made of an elastomeric material. When the support wall is not made of the elastomeric material, the height of the support wall 63 is less than the height h1 of the boundary wall 62.

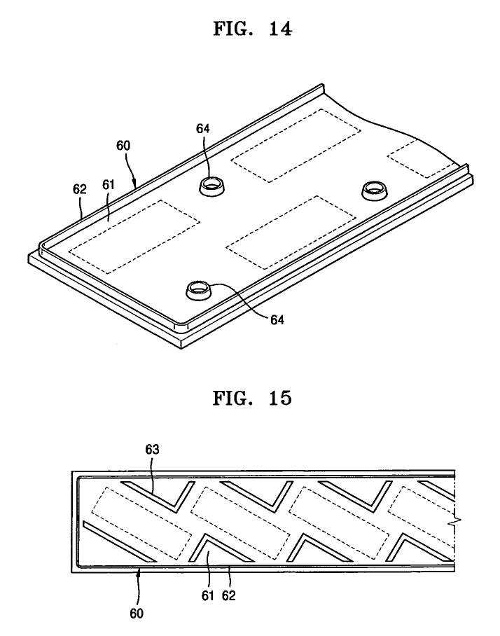

FIG. 14 illustrates another embodiment of the protector, in which a support pole 64 protrudes from the base 61. It will be understood by those skilled in the art that other modifications or alterations may be made. FIG. 15 illustrates an embodiment of the cap member 60 to cap the printbar 11 illustrated in FIG. 3. It will be understood by those skilled in the art that the protector may be altered in various ways depending on the arrangement of the nozzle plates 12.

The height h1 of the boundary wall 62 may be reduced by about 0.8 mm by the protector described above included in the cap member 60, and the height h1 may be even further reduced.

The cap member usable with an ink-jet image forming apparatus according to various embodiments of the present general inventive concept is characterized by including the protector to prevent the printbar 11 from contacting the base 61 of the cap member 60. The unit that moves the platen 30, as illustrated in FIGS. 4 and 5, and the unit that moves the cap member 60 between the capping position and the uncapping position, as illustrated in FIGS. 6 through 8, are exemplary non-limiting embodiments of the present general inventive concept. Although the ink-jet image forming apparatus employing the array ink-jet head is described herein, the present general inventive concept may be applied to an ink-jet image forming apparatus employing a shuttle-type ink-jet head. To increase the resolution, the printbar of the shuttle-type ink-jet head may be provided with a plurality of nozzle plates, which may extend in the main scanning direction and/or the subscanning direction of the printbar. In this case, it will be understood by those skilled in the art that the cap member 60 of the embodiments described above may be applied. In the case of the shuttle-type ink-jet image forming apparatus, the cap member 60 is installed on a service station, and when the ink-jet head arrives at the service station, the cap member 60 caps the printbar.

According to various embodiments of the ink-jet image forming apparatus of the present general inventive concept, a volume of air isolated when a printbar is capped is minimized to reduce vaporization of ink and simultaneously prevent damage to nozzles disposed on the printbar due to contact of the printbar and a cap member.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink-jet image forming apparatus, comprising:
an ink-jet head including a printbar having a plurality of nozzle plates; and
a cap member including:
a base facing the printbar,
a boundary wall disposed against the base to seal the printbar, and
a protector protruding from the base to prevent the printbar from contacting the base.

2. The ink-jet image forming apparatus of claim 1, wherein the protector includes a support pole disposed at a region of the base that does not face one of the plurality of nozzle plates.

3. The ink-jet image forming apparatus of claim 2, wherein the support pole has a height equal to or lower than a height of the boundary wall.

4. The ink-jet image forming apparatus of claim 1, wherein the protector is disposed at a region of the base that does not face one of the plurality of nozzle plates, and includes a support wall extending along an edge of one of the plurality of nozzle plates.

5. The ink-jet image forming apparatus of claim 4, wherein the support wall has a height equal to or lower than a height of the boundary wall.

6. The ink-jet image forming apparatus of claim 4, wherein the support wall is separated from the boundary wall.

7. The ink-jet image forming apparatus of claim 1, wherein the printbar has a main scanning direction corresponding to a width of a recording medium.

8. The ink-jet image forming apparatus of claim 1, wherein the cap member is made of an elastic material.

9. An ink-jet image forming apparatus, comprising:
an array ink-jet head including a printbar having a length in a main scanning direction corresponding to at least a width of a recording medium, the printbar having a plurality of nozzle plates; and
a cap member including a base facing the printbar, an elastomeric boundary wall disposed against the base to seal the printbar, and a support wall having a height equal to or lower than a height of the boundary wall and disposed at a region of the base that does not face one of the plurality of nozzle plates.

10. The ink-jet image forming apparatus of claim 9, wherein the support wall is disposed along an edge of one of the plurality of nozzle plates.

11. The ink-jet image forming apparatus of claim 10, wherein the support wall is separated from the boundary wall.

12. An ink-jet image forming apparatus having a printhead with nozzle plates, comprising:
a cap member to seal the printhead while a printing operation is not performed, the cap member including a protector to prevent the cap member from contacting the nozzle plates by maintaining at least a predetermined distance between the cap member and the printhead.

13. The ink-jet image forming apparatus of claim 12, wherein the cap member comprises:
a base to face the printhead, wherein the protector is disposed on the base in regions that do not face one of the nozzle plates; and
a boundary wall around edges of a surface of the base towards the printhead.

14. The ink-jet image forming apparatus of claim 13, wherein the protector comprises a support wall substantially surrounding the regions of the base that do not face one of the nozzle plates.

15. The ink-jet image forming apparatus of claim 13, wherein the protector comprises protrusions.

16. The ink-jet image forming apparatus of claim 13, wherein the protector has a protector height equal to or smaller than a boundary height of the boundary wall if the protector is made of an elastomeric material, and the protector height is smaller than the boundary height if the protector is made of a rigid material.

17. The ink-jet image forming apparatus of claim 12, further comprising:
a platen to support a side of a recording medium conveyed under the printhead during the printing operation; and
a platen-moving unit to move the platen between a first position during the printing operation, and a second position while the printing operation is not performed, to allow the cap member to seal the printhead.

18. The ink-jet image forming apparatus of claim 17, further comprising:
a cap-member moving unit to move the cap member between an uncapped position during the printing operation, and a capping position while the printing operation is not performed, after the platen has been removed by the platen-moving unit.

19. The ink-jet image forming apparatus of claim 18, wherein the cap member moving unit and the platen-moving unit move due to at least one electric motor.

20. A nozzle protecting system usable with an ink-jet image printing apparatus to prevent dried ink and dust from clogging ink ejecting nozzles while a printing operation is not performed, the system comprising:
a cap member including a plurality of protrusions to prevent the cap member from contacting the nozzles by maintaining a predetermined distance between the cap member and the nozzles;
a platen moving unit to move a platen between a first position during the printing operation and a second position when the printing operation is not performed; and
a cap-member moving unit to move the cap member to cover the ink ejecting nozzles after the platen has been moved in the second position.
